(19) United States
(12) Patent Application Publication
(10) Pub. No.: US 2025/0054408 A1
(43) Pub. Date: Feb. 13, 2025

(54) Systems, Methods, and Devices for Facilitating Phonetic Education

(71) Applicant: Alyssa Baird, Buda, TX (US)

(72) Inventor: Alyssa Baird, Buda, TX (US)

(21) Appl. No.: 18/800,650

(22) Filed: Aug. 12, 2024

Related U.S. Application Data
(60) Provisional application No. 63/531,972, filed on Aug. 10, 2023.

(51) Int. Cl. G09B 17/00; G09B 5/06

(52) U.S. Cl. CPC G09B 17/006; G09B 5/06

(57) ABSTRACT

The present disclosure provides systems, methods, and devices for facilitating phonetic education. A phonetic education device may comprise a body shaped like at least one character or symbol, such as a letter or number, as well as at least one audio emitting device configured to emit at least one audio sound comprising a phoneme associated with a grapheme represented by the body of the phonetic education device. The audio sound may be emitted when at least one activation mechanism, such as a button or pressure sensor, is manipulated or engaged by at least one user. In some implementations, a phonetic education system may comprise one or more phonetic education devices configured to transmit data to at least one computing device, wherein the computing device may comprise one or more coded instructions or algorithms configured to facilitate one or more interactions between the user and the phonetic education devices.

### CROSS-REFERENCE TO RELATED APPLICATION

This application claims priority to and the full benefit of U.S. Provisional Patent Application Ser. No. 63/531,972 (filed Aug. 10, 2023, and titled “SYSTEMS, METHODS, AND DEVICES FOR FACILITATING PHONETIC EDUCATION”), the entire contents of which are incorporated in this application by reference.

### BACKGROUND

As children, we are tasked with learning how to understand, speak, read, and write language. These skills are difficult and confusing, especially when combined with the unique grammar rules, pronunciation variations, and vast vocabulary of the English language. Luckily, humans have developed a variety of educational tools and practices to address language at an early language.

While speaking a language often comes with exposure, reading and writing typically requires learning and practice. Even so, learning to speak a language may be greatly enhanced with certain tools and practices. For example, some may use letter blocks, reading books, or children's videos to teach children language. These techniques help convey language in a simplified way that may be better understood and retained by children.

In some ways, these practices and techniques may also extend to learning numbers and mathematics. Together with language, mathematics is an important educational hurdle for children. Language and mathematics are typically prerequisites to learning other types of materials. If a child does not have a basic understanding of these topics, they will likely struggle to learn other types of material.

Therefore, a certain urgency develops from the desire to teach children language and mathematics at a very early age. While there are techniques, tools, and practices to accomplish these things, they often struggle to encompass a variety of skills in one. Instead, they focus on a single element of learning, giving children a less than holistic approach to learning.

What is needed is a way to teach children language and mathematics together. If a device or practice can help understand, speak, read, write, add, and subtract, a child may be able to develop quicker and more effectively. These tools may enable children to learn more complex and advanced topics at a younger age. This type of approach may not replace but work alongside current techniques and practices to enhance a child's learning experience.

### SUMMARY OF THE DISCLOSURE

What is needed is a systems, methods, and devices for facilitating phonetic education enhances the teaching of alphanumerical characters and properties. The present disclosure details various example features of systems, methods, and devices for facilitating phonetic education that may teach children language and mathematics together.

A number of embodiments of the present disclosure will be described. While this specification contains many specific implementation details, these should not be construed as limitations on the scope of any disclosures or of what may be claimed, but rather as descriptions of features specific to particular embodiments of the present disclosure. It is understood to those skilled in the art that variations, modifications, and alterations may be apparent. It will be understood that various modifications may be made without departing from the spirit and scope of the disclosure.

In some embodiments, a phonetic education device is disclosed. In some implementations, the phonetic education device may include a soft and durable body that is shaped as a three-dimensional representation of at least one alphanumerical character. In some embodiments, the soft and durable body may include an exterior surface and an internal portion. In some aspects, one or more attachment mechanisms may be located within the internal portion of the body or on the exterior surface of the body, wherein the one or more attachment mechanism is configured to at least temporarily secure the phonetic education device to at least one external device. In some implementations, an audio emitting device may be located in the internal portion of the body, wherein a first prerecorded audio may be stored in at least one storage medium within the audio emitting device, wherein the first prerecorded audio corresponds to the at least one alphanumerical character represented by the body.

In some embodiments, an activation mechanism on the exterior surface of the body, wherein the activation mechanism includes at least one electronic component that may be communicatively coupled to the audio emitting device, wherein the at least one manipulation of activation mechanism may cause at least the first prerecorded audio to be emitted from the audio emitting device. In some aspects, the at least one external device may be a second phonetic education device. In some implementations, the audio emitting device may be configured to emit a second prerecorded audio representative of a combination of the at least one alphanumerical characters of a first phonetic education device and the second phonetic education device.

In some embodiments, the internal portion of the body may include at least one controller communicatively coupled to the activation mechanism and audio emitting device such that the controller directs the audio emitting device to emit at least one prerecorded audio when at least one input signal is received from the activation mechanism. In some aspects, at least one visual indicator on the exterior surface of the body, wherein the visual indicator includes a visual representation of at least one sound to be emitted from the at least one audio emitting device. In some aspects, the internal portion of the body may include a power source configured to receive an electric current from at least one external power source via a receiving mechanism.

In some embodiments, a phonetic education system is disclosed. In some implementations, the phonetic education system includes a plurality of phonetic education devices. In some embodiments, the plurality of phonetic education devices may include a soft durable body, wherein the soft and durable body may be shaped as a three-dimensional representation of at least one alphanumerical character. In some aspects, the soft and durable body may include an exterior surface of the body and an interior portion of the body. In some implementations, one or more attachment mechanism may be located within the internal portion of the body or on the exterior surface of the body, wherein the one or more attachment mechanisms is configured to at least temporarily secure the phonetic education device to at least one other phonetic education device.

In some aspects, an audio emitting device may be located in the internal portion of the body, wherein a first prerecorded audio may be stored in at least one storage medium within the audio emitting device, wherein the at least one prerecorded audio corresponds to the at least one alphanumerical character represented by the body. In some implementations, an activation mechanism may be located on the exterior surface of the body, wherein the activation mechanism may include at least one electronic component that may be communicatively coupled to the audio emitting device, wherein the at least one manipulation of the activation mechanism that may cause the first prerecorded audio to be entitled from the audio emitting device.

In some embodiments, at least one controller device may be communicatively coupled to the activation mechanism and audio emitting device such that the controller device directs the audio emitting device to emit the first prerecorded audio when at least one input signal may be received from the activation mechanism. In some aspects, at least one sensing device may be communicatively coupled to the at least one controller device, wherein the at least one sensing device may be configured to detect and determine the presence of an adjacent phonetic device and may prompt the at least one audio emitting device to emit an audio representation of the combination of the alphanumerical characters of the coupled plurality of phonetic education devices.

In some embodiments, the plurality of phonetic education devices may include a mathematical symbol, wherein placing the mathematical symbol between at least a portion of the plurality of phonetic education devices may prompt the at least one audio emitting device to emit an audio representation of the combination of the alphanumerical characters and coupled mathematical symbols. In some aspects, the plurality of phonetic education devices may include a punctuation mark, wherein placing the punctuation mark between at least a portion of the plurality of phonetic education devices may prompt the at least one audio emitting device to emit an audio representation of the combination of alphanumerical symbols as modified by the punctuation mark. In some implementations, at least one audio emitting device may be configured to emit a second prerecorded audio corresponding to a notification sound if the plurality of phonetic education devices that may be adjacent to one another cannot logically combine.

In some embodiments, the at least one sensing device may be in the form of a proximity sensor. In some aspects, one or more software instructions within the controller may provide instructions via the at least one audio emitting device on how to spell or add certain alphanumerical shapes. In some implementations, at least a portion of the plurality of phonetic education systems may include at least one transmitting device, wherein the transmitting device may be communicatively coupled to at least one controller to enable each phonetic education device to transmit data wirelessly to at least one computing device. In some aspects, the at least one computing device may include a software application configured to direct a user to form one or more combinations of the plurality of phonetic education devices.

In some embodiments, the at least one computing device may be configured to present an image or picture to a user via at least one display screen. In some aspects, the plurality of phonetic education devices may include at least one connecting mechanisms to physically join at least a portion of the adjacent phonetic education devices. In some implementations, the at least one connecting device may be a magnet. In some aspects, the magnets of each phonetic education device may be communicatively coupled to at least one controller associated therewith, such that the controllers of coupled phonetic education devices may be able to determine an ordered sequence of the joined phonetic education devices.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1A illustrates an exemplary phonetic education device, according to some embodiments of the present disclosure.

FIG. 1B illustrates an exemplary phonetic education device, according to some embodiments of the present disclosure.

FIG. 1C illustrates an exemplary phonetic education device, according to some embodiments of the present disclosure.

FIG. 2A illustrates an exemplary phonetic education device, according to some embodiments of the present disclosure.

FIG. 2B illustrates an exemplary phonetic education device, according to some embodiments of the present disclosure.

FIG. 2C illustrates an exemplary phonetic education device, according to some embodiments of the present disclosure.

FIG. 3 illustrates a rear cutaway view of an exemplary phonetic education device, according to some embodiments of the present disclosure.

FIG. 4A illustrates an exemplary phonetic education system comprising a plurality of exemplary phonetic education devices, according to some embodiments of the present disclosure.

FIG. 4B illustrates an exemplary phonetic education system comprising a plurality of exemplary phonetic education devices, according to some embodiments of the present disclosure.

FIG. 5A illustrates an exemplary phonetic education system, according to some embodiments of the present disclosure.

FIG. 5B illustrates an exemplary phonetic education system, according to some embodiments of the present disclosure.

FIG. 6A illustrates an exemplary phonetic education system, according to some embodiments of the present disclosure.

FIG. 6B illustrates an exemplary phonetic education system, according to some embodiments of the present disclosure.

FIG. 7A illustrates an exemplary phonetic education system, according to some embodiments of the present disclosure.

FIG. 7B illustrates an exemplary phonetic education system, according to some embodiments of the present disclosure.

FIG. 8 illustrates an exemplary graphical user interface for a phonetic education system, according to some embodiments of the present disclosure.

FIG. 9 illustrates an exemplary phonetic education system, according to some embodiments of the present disclosure.

FIG. 10 illustrates a block diagram of an exemplary embodiment of a computing device that may be utilized within a phonetic education system, according to some embodiments of the present disclosure.

The Figures are not necessarily drawn to scale, as their dimensions can be varied considerably without departing from the scope of the present disclosure.

### DETAILED DESCRIPTION

The present disclosure provides generally for systems, methods, and devices for facilitating phonetic education. According to the present disclosure, a phonetic education device may comprise a body shaped as one or more letters, numbers, symbols, punctuation marks, or other characters. In some aspects, an internal or external portion of the phonetic education device may comprise one or more audio emitting devices, such as speakers. In some implementations, the audio emitting device may be communicatively coupled to at least one activation mechanism, wherein the activation mechanism and the audio emitting device may be communicatively coupled to at least one controller such that when the activation mechanism is engaged by a user, the controller causes one or more prerecorded sounds, words, or phrases stored within at least one storage medium to be emitted from the audio emitting device. In some embodiments, the audio emitted from the audio emitting device may be related to the shape of the body of the phonetic education device such that the user may form an association between the emitted audio and the character or symbol represented by the phonetic education device.

In some aspects, a phonetic education system may comprise one or more phonetic education devices, wherein the controller of each phonetic education device may be communicatively coupled to at least one user computing device. In some implementations, the user computing device may comprise one or more coded instructions or algorithms, such as, for example and not limitation, a software application stored within at least one storage medium and executed by at least one processor of the computing device, wherein the coded instructions or algorithms may facilitate one or more interactions between the phonetic education device(s) and the user computing device that may be displayed via at least one graphical user interface generated and displayed by the user computing device. In some embodiments, two or more phonetic education devices may be configured to interact with each other, wherein interaction amongst a plurality of phonetic education devices may affect the audio emitted by the audio emitting devices of one or more of the phonetic education devices or the presentation displayed via the graphical user interface, as non-limiting examples.

In the following sections, detailed descriptions of examples and methods of the disclosure will be given. The descriptions of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Phonetic education device: as used herein refers to any device configured to facilitate a user's association of a phoneme with its associated grapheme. By way of example and not limitation, a phonetic education device may comprise a body shaped as one or more letters, numbers, symbols, punctuation marks, or other characters, as well as at least one audio emitting device, wherein the audio emitting device may be configured to emit at least one audio sound when at least one activation mechanism is engaged by at least one user, wherein the audio sound may be indicative of a phoneme of a grapheme represented by the body of the phonetic education device.

Activation mechanism: as used herein refers to any physical or electronic component that may be configured to be manipulated by at least one user or to be engaged by at least one user. In some aspects, the activation mechanism may be communicatively coupled to at least one audio emitting device such that when a user manipulates or engages the activation mechanism, the activation mechanism may cause the audio emitting device to emit at least one audio sound. In some implementations, the activation mechanism and the audio emitting device may be communicatively coupled via at least one controller, wherein the controller may instruct the audio emitting device to emit at least one audio sound when the activation mechanism is manipulated or otherwise engaged.

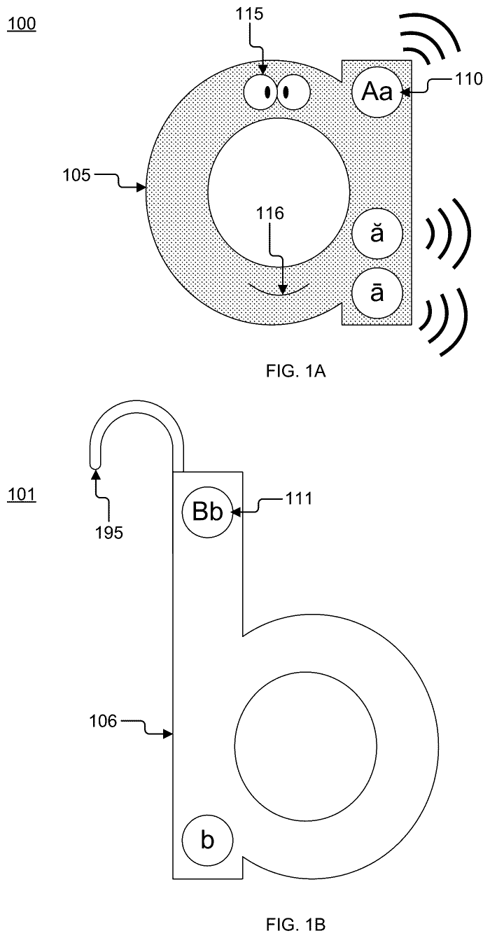

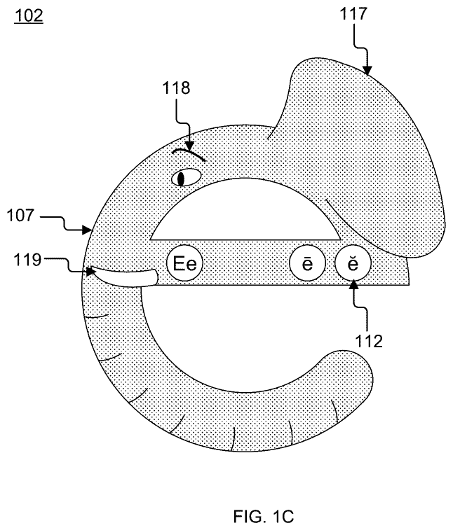

Referring now to FIGS. 1A-1C, exemplary phonetic education devices 100, 101, 102, according to some embodiments of the present disclosure, are illustrated.

In some aspects, each phonetic education device 100, 101, 102 may comprise a body 105, 106, 107. In some implementations, the body 105, 106, 107 may comprise a shape that comprises a two-dimensional or three-dimensional representation of at least one letter, number, symbol, punctuation mark, or similar character. By way of example and not limitation, the body 105, 106, 107 may be shaped as one or more of: a letter or symbol of any language, a number, a mathematical symbol, a currency or monetary symbol, a punctuation mark, a hieroglyph, or any similar marking. In some non-limiting illustrative embodiments, the body 105, 106, 107 may comprise a combination of one or more materials, structures, and/or coverings that may be soft and/or durable, such as plastic, plush, elastic, or rubber, as non-limiting examples. In some aspects, an exterior surface of the body 105, 106, 107, such as, for example and not limitation, a top portion of the exterior surface, may comprise one or more attachment mechanisms 195 configured to at least temporarily secure the phonetic education device 100, 101, 102 to at least one external object or device. By way of example and not limitation, the attachment mechanism 195 may comprise one or more of: a hook, a magnet, a clasp, a clamp, a clip, a snapping mechanism, a hook-and-loop fastener, a suction device, a pin, or any similar device or mechanism.

In some implementations, at least one portion of an exterior surface of each phonetic education device 100, 101, 102 may comprise at least one visual indicator 110, 111, 112 proximate to one or more activation mechanisms that may be integrated within or upon the phonetic education device 100, 101, 102. In some aspects, each visual indicator 110, 111, 112 may comprise a visual representation of at least one sound to be emitted from at least one audio emitting device embedded within or secured upon the phonetic education device 100, 101, 102 when the activation mechanism is manipulated or engaged by at least one user of the phonetic education device 100, 101, 102. In some embodiments, each visual indicator 110, 111, 112 may be configured at a location upon a portion of the exterior surface of the phonetic education device 100, 101, 102 that may be indicative of the location of the activation mechanism associated therewith, whether the activation mechanism may be integrated with or otherwise configured upon or within the surface of the phonetic education device 100, 101, 102 or whether the activation mechanism nay be configured internally within the phonetic education device 100, 101, 102 below the portion of the external surface where the corresponding visual indicator 110, 111, 112 may be configured.

In some aspects, each activation mechanism may comprise at least one physical and/or electronic component that may be manipulated or engaged by at least one user. By way of example and not limitation, the activation mechanism may comprise one or more of: a button, a pressure sensor, a switch, a knob, a motion sensor, a presence sensor, a microphone, or a camera, as non-limiting examples. In some implementations, the activation mechanism may be communicatively coupled to at least one audio emitting device, such as, for example and not limitation, a speaker, and at least one storage medium, such that when the activation mechanism receives at least one manipulation, engagement, or other input from a user, the activation mechanism may cause at least one prerecorded audio sound to be emitted from the audio emitting device, wherein the prerecorded sound may be at least temporarily stored within the storage medium. In some non-limiting exemplary embodiments, the prerecorded audio may be stored within the storage medium prior to or during the manufacturing process of the phonetic education device 100, 101, 102, or the prerecorded audio may comprise at least one audio recording received from at least user of the phonetic education device 100, 101, 102 via at least one microphone or similar audio receiving device. As a non-limiting illustrative example, a parent or teacher may submit audio via at least one microphone before giving the phonetic education device 100, 101, 102 to a child for use-based learning.

In some implementations, the phonetic education device 100, 101, 102 may comprise at least one controller. In some embodiments, the controller may be configured within an internal portion of the phonetic education device 100, 101, 102 to protect the controller from damage or tampering. In some aspects, the controller may be communicatively coupled to the activation mechanism(s) as well as the audio emitting device(s) such that the controller may direct one or more of the audio emitting devices to emit one or more audio sounds when at least one input signal is received from at least one of the activation mechanisms. In some non-limiting exemplary implementations, the controller may comprise at least one storage medium wherein one or more prerecorded audio sounds may be at least temporarily stored, or the controller may be communicatively coupled to the storage medium wherein one or more prerecorded audio sounds may be stored.

In some aspects, the prerecorded audio sounds stored within the storage medium of the phonetic education device 100, 101, 102 may comprise a name of the character or symbol represented by the body 105, 106, 107 of the phonetic education device 100, 101, 102, as well as one or more sounds indicated or represented by the character or symbol associated with the shape of the body 105, 106, 107. As a non-limiting illustrative example, the shape of the body 105 of the phonetic education device 100 may comprise the letter “a,” and so a first visual indicator 110 may indicate that when a first activation mechanism is engaged, an audio sound may be emitted from one or more speakers that comprises a verbalization that the body 105 of the phonetic education device 100 comprises the shape of the letter “a.” In some aspects, because the letter “a” is a vowel, multiple sounds, or phonemes, may be associated with the grapheme comprising the letter. Therefore, in some implementations, a second visual indicator 110 may indicate that when a second activation mechanism is engaged, an audio sound may be emitted from one or more speakers that comprises the short “a” vowel sound, while a third visual indicator 110 may indicate that when a third activation mechanism is engaged, an audio sound may be emitted from one or more speakers that comprises the long “a” vowel sound.

In some embodiments, only one phoneme may be associated with a phonetic education device 101 that comprises a consonant, such as, for example and not limitation, the letter “b,” as well as most types of other symbols or characters, so only one visual indicator 111 may be needed that depicts the phoneme associated with the grapheme represented by the phonetic education device 101.

In some implementations, the phonetic education device 100, 101, 102 may comprise one or more aesthetic elements 115, 116, 117, 118, 119. In some aspects, the aesthetic elements 115, 116, 117, 118, 119 may make the phonetic education device 100, 101, 102 more appealing, entertaining, or desirable to use for a user, particularly when the user may comprise a young child. In some implementations, the appealing nature of the aesthetic elements 115, 116, 117, 118, 119 may increase the likelihood that the user may use the phonetic education device 100, 101, 102 and receive one or more benefits that may be associated with such usage. By way of example and not limitation, the aesthetic elements 115, 116, 117, 118, 119 may comprise one or more visual features that personify the phonetic education device 100, 101, 102, such as eyes, a mouth, a nose, or cars, as non-limiting examples, as well as any combination thereof.

As a non-limiting illustrative example, one or more phonetic education devices 100, 101, 102 may comprise letters of the English alphabet. In some aspects, each phonetic education device 100, 101, 102 may comprise a body 105, 106, 107 in the shape of a letter, such as a body 105 that comprises the letter “a” or a body 106 that comprises the letter “b.” In some implementations, each body 105, 106 of each phonetic education device 100, 101 may comprise a generally soft configuration with a plush exterior, wherein an internal portion of the body 105, 106 may comprise an amount of cotton, foam, or polyester, as non-limiting examples, or any similar soft material, as well as any combination thereof. In some non-limiting exemplary embodiments, at least one of the phonetic education devices 100 may comprise one or more aesthetic elements 115, 116, such as, for example and not limitation, eyes 115 and a mouth 116, which may make the phonetic education device 100 more fun or appealing to young users.

In some implementations, one or more phonetic education devices 100, 101, 102 may comprise a body 105, 106, 107 that comprises a shape or design that represents an animal, person, or object associated with the phonetic education device 105, 106, 107 in some way. As a non-limiting illustrative example, a phonetic education device 102 may comprise a body 107 that comprises the shape of a letter of the English alphabet as well as one or more aesthetic elements 117, 118, 119 that may cause the phonetic education device 102 to represent an animal with a name that starts with that letter. By way of example and not limitation, the phonetic education device 102 may comprise a body 107 shaped like the letter “e,” as well as a plurality of aesthetic elements 117, 118, 119 that may cause the phonetic education device 102 to represent an elephant, such as an car 117, an eye 118, and a tusk 119, as non-limiting examples.

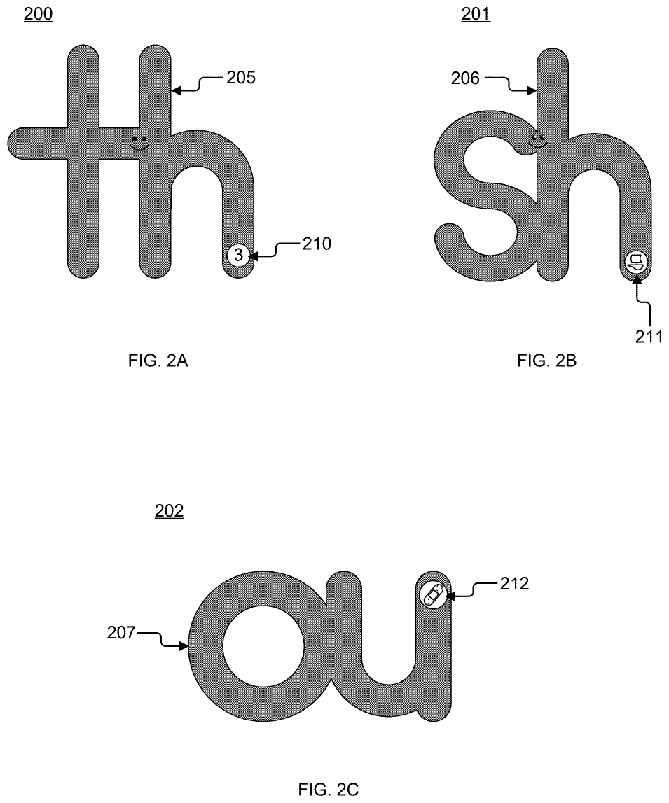

Referring now to FIGS. 2A-2C, exemplary phonetic education devices 200, 201, 202, according to some embodiments of the present disclosure, are illustrated.

In some aspects, a phonetic education device 200, 201, 202 may comprise a body 205, 206, 207 that comprises a shape that comprises a combination of two or more letters or symbols of any language, or two or more numbers, mathematical symbols, currency or monetary symbols, punctuation marks, hieroglyphs, or any similar markings, as well as any combination thereof. In some implementations, a combination of symbols, markings, or characters may comprise a grapheme with a special meaning or phoneme such that a phonetic education device 200, 201, 202 may assist a user with associating such unique phonemes with their associated graphemes. By way of example and not limitation, a phonetic education device 200, 201, 202 may comprise a body 205, 206, 207 shaped as a combination of at least two letters of the English alphabet, wherein the body 205, 206, 207 may comprise letters that form at least one digraph, such as “th,” “ou,” or “sh,” as non-limiting examples.

In some implementations, an exterior portion of the body 205, 206, 207 may comprise at least one visual indicator 210, 211, 212 that comprises a visual indication, hint, or reminder of the phoneme associated with the grapheme represented by each phonetic education device 200, 201, 202. By way of example and not limitation, a phonetic education device 200 that comprises a body 205 shaped like the “th” digraph may comprise a visual indicator 210 that comprises the number three, such that a user may be reminded that the phoneme that corresponds to the “th” grapheme is the sound that forms the beginning of the verbalization of the word “three.” As an additional non-limiting illustrative example, a phonetic education device 201 that comprises a body 206 shaped like the digraph “sh” may comprise a visual indicator 211 that comprises a picture or image of a ship, such that a user may be reminded that the phoneme that corresponds to the “sh” grapheme is the sound that forms the beginning of the verbalization of the word “ship.” By way of further example and not limitation, a phonetic education device 202 that comprises a body 207 shaped like the “ou” digraph may comprise a visual indicator 212 that comprises an image or picture of a bandage such that a user may be given a hint or reminder that the phoneme that corresponds to the “ou” grapheme is the sound that forms the beginning portion of the verbalization of the word “ouch.”

In some aspects, each visual indicator 210, 211, 212 of each phonetic education device 200, 201, 202 associated therewith may be configured proximate to at least one activation mechanism that may be manipulated or engaged to cause at least one audio emitting device to broadcast or emit audio comprising a phoneme or other sound associated with or represented by the shape of the body 205, 206, 207 of the phonetic education device 200, 201, 202 such that a user may be able to learn, confirm, or verify an association between the sound and the shape of the phonetic education device 200, 201, 202.

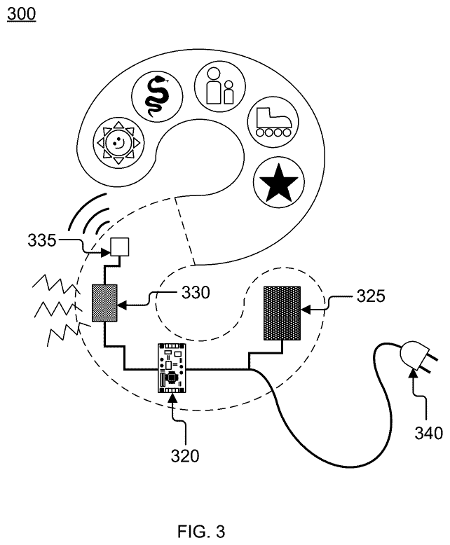

Referring now to FIG. 3, a rear cutaway view of an exemplary phonetic education device 300, according to some embodiments of the present disclosure, is illustrated.

In some aspects, a phonetic education device 300 may comprise one or more electronic components that facilitate the functionality of the phonetic education device 300. In some implementations, the electronic components may be configured within at least one internal portion of the phonetic education device 300. By way of example and not limitation, the phonetic education device 300 may comprise one or more of: at least one controller 320, at least one internal power source 325, at least one electromagnetic 330, at least one audio emitting device 335, and at least one receiving mechanism 340 (such as, for example and not limitation, a two- or three-prong attachment plug) for receiving an alternating or direct electrical current from at least one external power source. In some implementations, the electronic components of the phonetic education device 300 may be communicatively and/or electronically coupled such that the electronic components may interact with each other, such as to facilitate the flow of electricity or transfer data, as non-limiting examples.

In some non-limiting exemplary embodiments, the controller 320 of the phonetic education device 300 may be configured to direct the activation or performance of one or more of: the audio emitting device 335, the electromagnet 330, and the power source 325. In some implementations, the controller 320 may comprise or may be communicatively coupled to at least one storage medium that comprises one or more coded instructions or algorithms that may be executed by the controller 320 to control or regulate the functioning or execution of the various electronic components of the phonetic education device 300. In some aspects, the storage medium may further comprise one or more prerecorded sounds, words, or phrases that may be emitted by the audio emitting device 335 when instructed by the controller 320. By way of example and not limitation, the controller 320 may be communicatively coupled to one or more activation mechanisms associated with or proximate to one or more visual indicators 310 such that when each activation mechanism is manipulated or engaged by a user, the controller 320 may direct the audio emitting device 335 to emit at least one audio sound.

In some implementations, the internal power source 325 of the phonetic education device 300 may comprise at least one battery and/or at least one photovoltaic cell. In some embodiments, the internal power source 325 may comprise a rechargeable battery configured to receive an electric current from at least one external power source via the receiving mechanism 340. In some non-limiting exemplary implementations, the receiving mechanism 340 may be configured to facilitate recharging of the internal battery of the phonetic education device 300 via inductive charging. In some aspects, the controller 320 may regulate the flow of electricity from the external power source to the battery to prevent the battery from being damaged via overcharging.

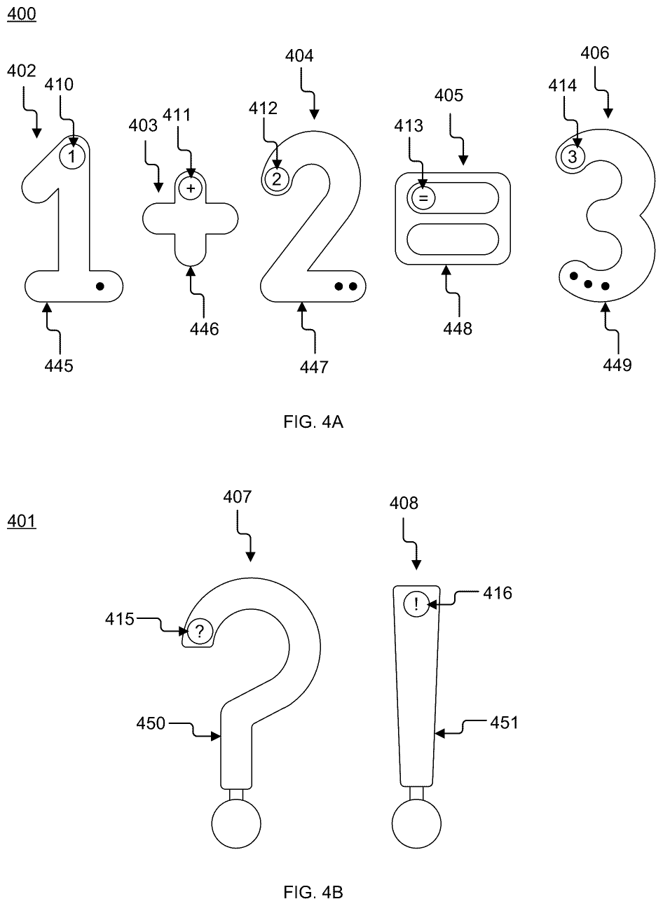

Referring now to FIGS. 4A-4B, exemplary phonetic education systems 400, 401 comprising a plurality of exemplary phonetic education devices 402, 403, 404, 405, 406, 407, 408, according to some embodiments of the present disclosure, are illustrated.

In some aspects, each phonetic education device 402, 403, 404, 405, 406, 407, 408 may comprise one or more of: a letter or symbol of any language, a number, a mathematical symbol, a currency or monetary symbol, a punctuation mark, a hieroglyph, or any similar marking, as non-limiting examples. In some implementations, an external portion of the body 445, 446, 447, 448, 449, 450, 451 of each phonetic education device 402, 403, 404, 405, 406, 407, 408 may comprise at least one visual indicator 410, 411, 412, 413, 414, 415, 416 that may be configured proximate to at least one activation mechanism configured to cause at least one audio emitting device to broadcast or emit at least one audio sound associated with the phonetic education device 402, 403, 404, 405, 406, 407, 408 when manipulated or engaged by at least one user.

As non-limiting illustrative examples, in some implementations the body 445, 446, 447, 448, 449, 450, 451 of a phonetic education device 402, 403, 404, 405, 406, 407, 408 may comprise a shape that comprises a number, a mathematical symbol, or a punctuation mark. By way of example and not limitation, the phonetic education device 402 may comprise a body 445 shaped like the number one, the phonetic education device 403 may comprise a body 446 shaped like an addition symbol, the phonetic education device 404 may comprise a body 447 shaped like the number two, the phonetic education device 405 may comprise a body 448 shaped like the “equals” symbol, the phonetic education device 406 may comprise a body 449 shaped like the number three, the phonetic education device 407 may comprise a body 450 shaped like a question mark, and the phonetic education device 408 may comprise a body 451 shaped like an exclamation mark.

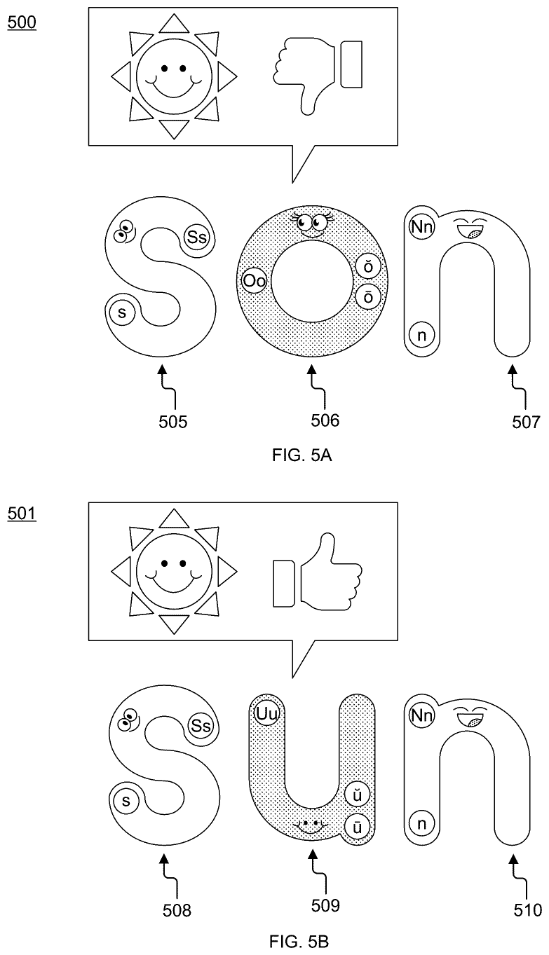

Referring now to FIGS. 5A-5B, exemplary phonetic education systems 500, 501, according to some embodiments of the present disclosure, are illustrated.

In some aspects, a phonetic education system 500, 501 may comprise a plurality of phonetic education devices 505, 506, 507, 508, 509, 510 configured to interact with each other. In some implementations, a controller of each phonetic education device 505, 506, 507, 508, 509, 510 may comprise one or more coded software instructions or algorithms that may enable the phonetic education devices 505, 506, 507, 508, 509, 510 to interact via one or more detections made by one or more sensing devices communicatively coupled to the controller of each phonetic education device 505, 506, 507, 508, 509, 510. By way of example and not limitation, each sensing device may comprise a proximity sensor or an electromagnet, as non-limiting examples.

As a non-limiting illustrative example, each phonetic education device 505, 506, 507, 508, 509, 510 may comprise at least one sensing device in the form of a proximity sensor. In some aspects, one or more software instructions within a controller of a phonetic education device 505, 508 shaped like the letter “s” may prompt a user to spell the word “sun,” wherein the prompt may be emitted via at least one audio emitting device and wherein the prompt may specify that the word “sun” pertains to the sun in the sky. In some implementations, the proximity sensor(s) of each phonetic education device 505, 506, 507, 508, 509, 510 may allow the controllers of the phonetic education devices 505, 506, 507, 508, 509, 510 to detect and determine which phonetic education devices 505, 506, 507, 508, 509, 510 are immediately adjacent to each other such that the controllers may be able to distinguish between a user arranging the phonetic education devices 505, 506, 507, 508, 509, 510 comprising letters in a sequence that forms the word “son” versus the word “sun.” In some implementations, this may allow the controller of at least one of the phonetic education devices 505, 506, 507, 508, 509, 510 to provide feedback to the user, such as, for example and not limitation, via at least one audio emitting device, by indicating whether the user correctly spelled the word “sun” or incorrectly spelled the word “son.” In some aspects, this may allow the user to learn to distinguish between different spellings of words that sound the same, such as homophones.

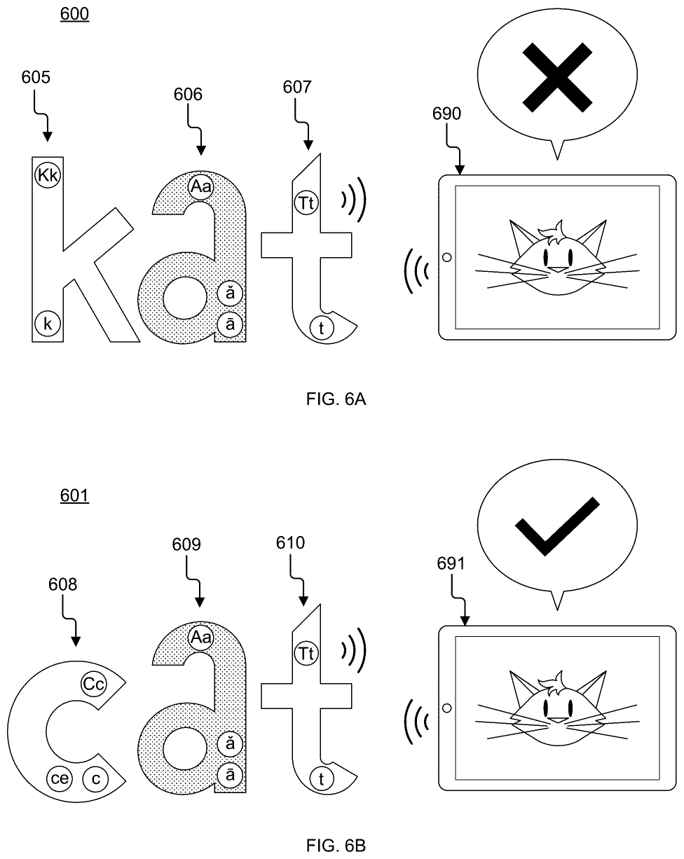

Referring now to FIGS. 6A-6B, exemplary phonetic education systems 600, 601, according to some embodiments of the present disclosure, are illustrated.

In some aspects, a phonetic education system 600, 601 may comprise a plurality of phonetic education devices 605, 606, 607, 608, 609, 610, wherein each phonetic education device 605, 606, 607, 608, 609, 610 may comprise at least one transmitting device communicatively coupled to at least one controller, wherein the transmitting device may enable each phonetic education device 605, 606, 607, 608, 609, 610 to transmit data wirelessly to at least one computing device 690, 691, such as via at least one network connection or at least one short-range wireless interconnection, as non-limiting examples.

In some implementations, the computing device 690, 691 may comprise one or more coded instructions or algorithms, such as, for example and not limitation, at least one software application downloaded from or accessed via one or more remote servers, such that the computing device 690, 691 may execute the instructions and direct a user to form one or more combinations of the phonetic education devices 605, 606, 607, 608, 609, 610, as well as verify whether the combinations were formed correctly. By way of example and not limitation, the computing device 690, 691 may comprise one or more of: a desktop computing device, a laptop computing device, a tablet computing device, or a smartphone, as non-limiting examples.

As a non-limiting illustrative example, the computing device 690, 691 may be configured to present a picture or image to a user via at least one display screen, wherein the image may prompt the user to arrange at least a portion of the phonetic education devices 605, 606, 607, 608, 609, 610 in an expected sequence. By way of example and not limitation, the phonetic education devices 605, 606, 607, 608, 609, 610 may comprise letters of the English alphabet, and the computing device 690, 691 may present an image of a cat to the user to prompt the user to spell the word “cat.” In some implementations, one or more proximity sensors or similar components within each phonetic education device 605, 606, 607, 608, 609, 610 may enable the computing device 690, 691 to distinguish and determine whether an arranged sequence of the phonetic education devices 605, 606, 607, 608, 609, 610 indicates if the user spells the word “cat” correctly. As a non-limiting illustrative example, the proximity sensors may allow the computing device 690, 691 to determine whether the user spelled “kat” or “cat,” wherein the computing device 690, 691 may be configured to provide positive feedback to the user upon spelling the word “cat” and negative feedback to the user upon spelling “kat.”

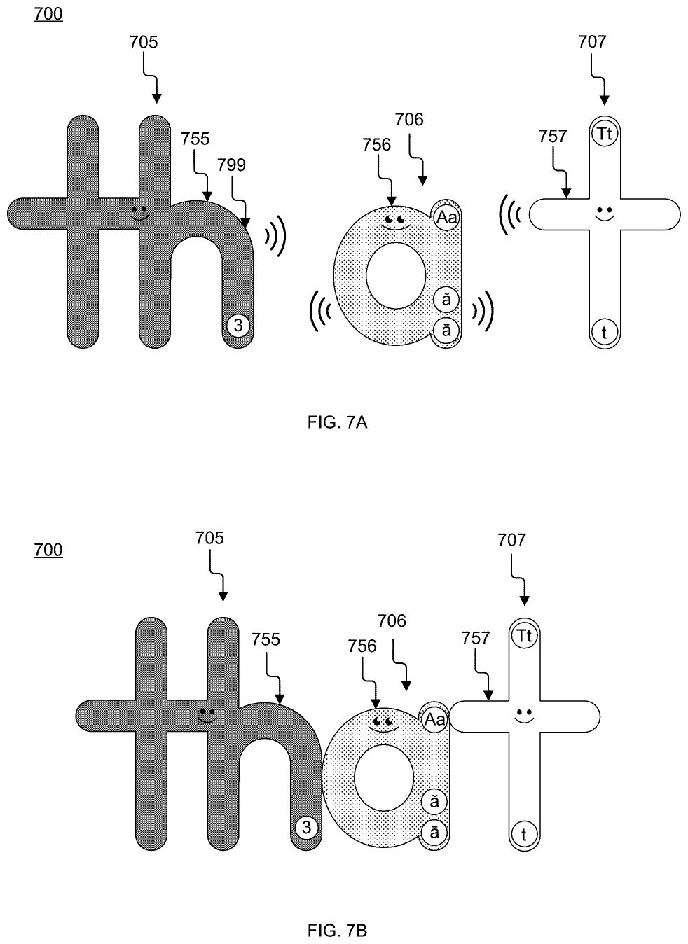

Referring now to FIGS. 7A-7B, an exemplary phonetic education system 700, according to some embodiments of the present disclosure, is illustrated.

In some aspects, a phonetic education system 700 may comprise a plurality of phonetic education devices 705, 706, 707. In some implementations, each phonetic education device 705, 706, 707 may comprise at least one connecting mechanism 799, such as, for example and not limitation, an electromagnet, such that adjacent phonetic education devices 705, 706, 707 may be physically joined via the alignment of corresponding electromagnets when placed within a maximum threshold proximity of one another. In some embodiments, the electromagnet(s) of each phonetic education device 705, 706, 707 may be communicatively coupled to at least one controller associated therewith, such that the controllers of combined phonetic education devices 705, 706, 707 may be able to determine an ordered sequence of the joined phonetic education devices 705, 706, 707 when the connected electromagnets complete one or more electrical circuits.

As a non-limiting illustrative example, a phonetic education device 705 may comprise a body 755 shaped like the “th” digraph, a phonetic education device 706 may comprise a body 756 shaped like the letter “a,” and a phonetic education device 707 may comprise a body 757 shaped like the letter “t.” In some aspects, a user may place the phonetic education devices 705, 706, 707 in an ordered sequence wherein the “th” comes first, followed by the “a,” and finally the “t.” In some implementations, once the user moves the arranged phonetic education devices 705, 706, 707 within a minimum threshold proximity of one another, the electromagnets embedded within or secured upon the phonetic education devices 705, 706, 707 may pull the phonetic education devices 705, 706, 707 together and at least temporarily connect the devices 705, 706, 707 such that the controllers of one or more of the phonetic education devices 705, 706, 707 may determine that the phonetic education devices 705, 706, 707 are arranged to form the word “that.” In some non-limiting exemplary embodiments, the arranged word may be broadcast or verbalized to the user via at least one audio emitting device integrated with at least one of the phonetic education devices 705, 706, 707, or the arranged word may be transmitted to at least one computing device via at least one transmitting device integrated with at least one of the phonetic education devices 705, 706, 707, wherein the computing device may be configured to present the arranged word to the user via at least one display screen and/or speaker integrated with or communicatively coupled to the computing device.

In some implementations, two or more phonetic education devices 705, 706, 707 may be configured to be removably connected via one or more connecting mechanisms 799. In some non-limiting exemplary embodiments, one or more connecting mechanisms 799 may be integrated with or affixed to at least one external portion of each of two or more phonetic education devices 705, 706, 707, such as, for example and not limitation, at least one side portion thereof, such that laterally adjacent phonetic education devices 705, 706, 707 may be at least temporarily secured together to form one or more words, phrases, sentences, numbers, or mathematical equations, as non-limiting examples. By way of example and not limitation, each connecting mechanism 799 may comprise one or more of: a magnet, an electromagnet, a snapping mechanism, a hook-and-loop fastener, a pin, a clip, a suction device, a clamp, a clasp, a suction device, corresponding male and female connectors, a tongue and groove connection, or a snap-fit mechanism, as non-limiting examples, as well as any similar connecting mechanisms 799 or any combination thereof.

In some aspects, securely connecting one or more formed words, phrases, sentences, numbers, or equations, even in a temporary manner, may allow a user to have more time to observe and study the visual appearance of a plurality of combined graphemes such that the user may use at least one activation mechanism associated with each phonetic education device 705, 706, 707 to emit an audio recording of the phoneme corresponding thereto such that the user may be able to associate the arrangement of a plurality of phonetic education devices 705, 706, 707 with a combination of phonemes, wherein at least one phoneme may be associated with each phonetic education device 705, 706, 707. As a non-limiting illustrative example, a plurality of phonetic education devices 705, 706, 707 may comprise letters, wherein a user may use one or more arrangements of the letters to form one or more words, phrases, or sentences, such that the user may learn to associate the pronunciation of each formed word, phrase, or sentence with the sequential order of phonemes associated with each letter or grouping of letters.

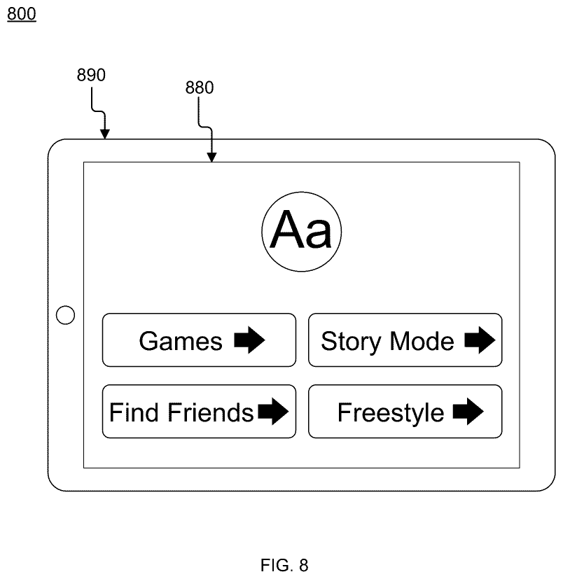

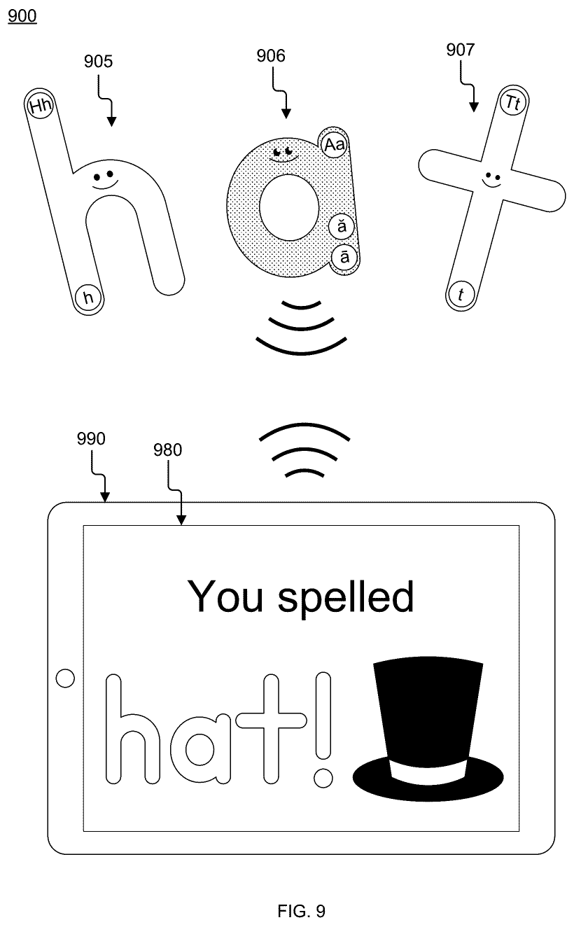

Referring now to FIG. 8, an exemplary graphical user interface 880 for a phonetic education system 800, according to some embodiments of the present disclosure, is illustrated.

In some aspects, the phonetic education system 800 may be configured to generate and present at least one graphical user interface (“GUI”) to at least one user via at least one computing device 890. In some implementations, the GUI 880 may be configured to present one or more selectable options or modes to the user for using the computing device 890 to interact with one or more phonetic education devices. In some embodiments, the user may select at least one option or mode using at least one input device integrated with or communicatively coupled to the computing device 890. By way of example and not limitation, the input device may comprise one or more of: a keyboard, a keypad, a touchscreen, a touchpad, a pointing device, a camera, a microphone, a motion sensor, or an accelerometer, as non-limiting examples.

In some non-limiting exemplary embodiments, the GUI 880 may allow a user to choose to use one or more phonetic education devices to play one or more games, such as, for example and not limitation, one or more word or math games. In some implementations, the user may be able to use the GUU 880 to search for and connect with other users of the phonetic education system 800, which may enable the user to play games with, compare or share lesson results with, or communicate with the other users, as non-limiting examples. In some aspects, the GUI may allow the user to select a story to read or listen to, such that the user may use one or more phonetic education devices to follow along with the story. As a non-limiting illustrative example, the user may use one or more phonetic education devices to form one or more words or sentences used in the story. In some implementations, the GUI 880 may allow the user to interact with the computing device 890 in a freestyle mode, wherein the user may be able to arrange one or more phonetic education devices in any desired order or sequence and obtain feedback from the computing device 890 regarding the order or sequence, such as, for example and not limitation, whether the order or sequence comprises one or more correctly spelled words or one or more correctly executed math equations, as non-limiting examples.

Referring now to FIG. 9, an exemplary phonetic education system 900, according to some embodiments of the present disclosure, is illustrated.

In some aspects, the phonetic education system 900 may comprise a plurality of phonetic education devices 905, 906, 907, wherein each phonetic education device 905, 906, 907 may comprise at least one transmitting device configured to transmit data to at least one computing device 990, such as via at least one network connection or at least one short-range wireless interconnection, as non-limiting examples. In some non-limiting exemplary embodiments, the phonetic education system 900 may be configured to generate and present at least one GUI 980 via the computing device 990 that may facilitate one or more interactions between at least one user and the phonetic education devices 905, 906, 907.

As a non-limiting illustrative example, a user may opt to use the phonetic education system 900 in a freestyle mode. In some aspects, this may allow the user to arrange the phonetic education devices 905, 906, 907 in any desired ordered sequence, wherein one or more proximity sensors, electromagnets, or similar sensing devices or electronic components within or upon each phonetic education device 905, 906, 907 may allow the computing device 990 to determine the ordered sequence of one or more phonetic education devices 905, 906, 907 and generate one or more visualizations or feedback pertaining to the ordered sequence. By way of example and not limitation, the user may use phonetic education devices 905, 906, 907 comprising letters of the English alphabet to form the word “hat,” and, upon determining the word “hat” was formed, the computing device 990 may confirm the spelling via the GUI 980 while also presenting the user with an image of a hat. In some aspects, this may make use of the phonetic education system 900 more entertaining or enjoyable for the user, which may increase the likelihood that the user will use the phonetic education system 900 and obtain one or more benefits associated with such usage.

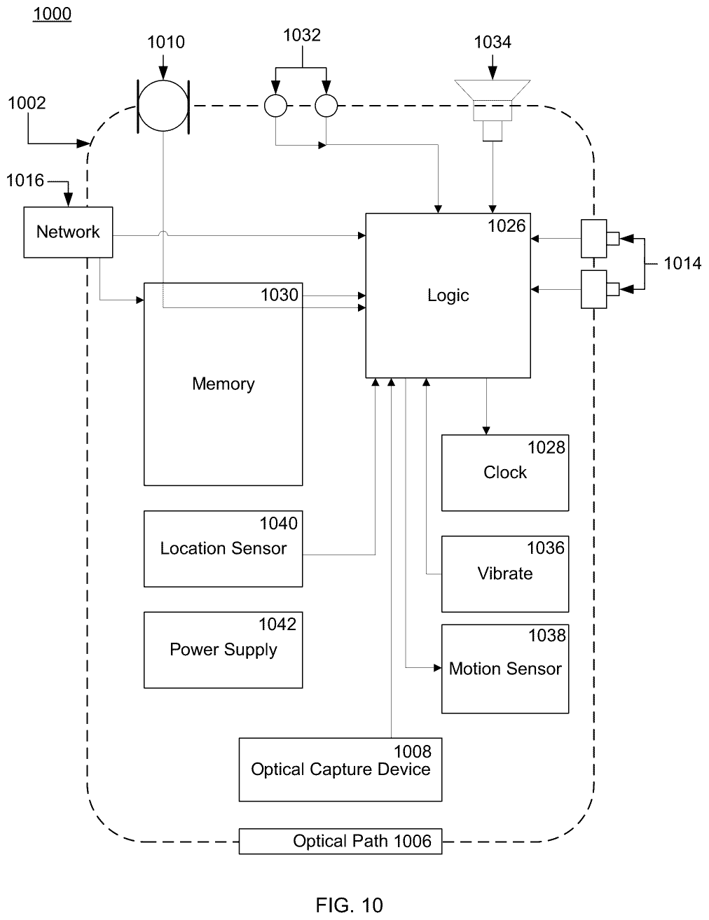

Referring now to FIG. 10, a block diagram of an exemplary embodiment of a computing device 1002 that may be utilized within a phonetic education system, according to some embodiments of the present disclosure, is illustrated.

In some aspects, the computing device 1002 may comprise an optical capture device 1008, which may capture an image and convert it to machine-compatible data, and an optical path 1006, typically a lens, an aperture, or an image conduit to convey the image from a rendered document to the optical capture device 1008. The optical capture device 1008 may incorporate a Charge-Coupled Device (CCD), a Complementary Metal Oxide Semiconductor (CMOS) imaging device, or an optical sensor of another type.

In some embodiments, the computing device 1002 may comprise a microphone 1010, wherein the microphone 1010 and associated circuitry may convert the sound of the environment, including spoken words, into machine-compatible signals. Input facilities 1014 may exist in the form of buttons, scroll-wheels, or other tactile sensors such as touchpads. In some embodiments, input facilities 1014 may include a touchscreen display. Visual feedback 1032 to the user may occur through a visual display, touchscreen display, or indicator lights. Audible feedback 1034 may be transmitted through a loudspeaker or other audio transducer. Tactile feedback may be provided through a vibration module 1036.

In some aspects, the computing device 1002 may comprise a motion sensor 1038, wherein the motion sensor 1038 and associated circuitry may convert the motion of the computing device 1002 into machine-compatible signals. For example, the motion sensor 1038 may comprise an accelerometer, which may be used to sense measurable physical acceleration, orientation, vibration, and other movements. In some embodiments, the motion sensor 1038 may comprise a gyroscope or other device to sense different motions.

In some implementations, the computing device 1002 may comprise a location sensor 1040, wherein the location sensor 1040 and associated circuitry may be used to determine the location of the device 1002. The location sensor 1040 may detect Global Position System (GPS) radio signals from satellites or may also use assisted GPS where the computing device 1002 may use a cellular network to decrease the time necessary to determine location. In some embodiments, the location sensor 1040 may use radio waves to determine the distance from known radio sources such as cellular towers to determine the location of the computing device 1002. In some embodiments these radio signals may be used in addition to and/or in conjunction with GPS.

In some aspects, the computing device 1002 may comprise a logic module 1026, which may place the components of the computing device 1002 into electrical and logical communication. In some implementations, the electrical and logical communication may allow the components to interact. Accordingly, in some embodiments, the received signals from the components may be processed into different formats and/or interpretations to allow for the logical communication.

The logic module 1026 may be operable to read and write data and program instructions stored in associated storage 1030, such as RAM, ROM, flash, or other suitable memory. In some aspects, the logic module 1026 may read a time signal from the clock unit 1028. In some embodiments, the computing device 1002 may comprise an on-board power supply 1042. In some embodiments, the computing device 1002 may be powered from a tethered connection to another device, such as a Universal Serial Bus (USB) connection.

In some implementations, the computing device 1002 may comprise a network interface 1016, which may allow the computing device 1002 to communicate and/or receive data to a network and/or an associated computing device. The network interface 1016 may provide two-way data communication.

For example, the network interface 1016 may operate according to an internet protocol. As another example, the network interface 1016 may comprise a local area network (“LAN”) card, which may allow a data communication connection to a compatible LAN. As another example, the network interface 1016 may comprise a cellular antenna and associated circuitry, which may allow the computing device 1002 to communicate over standard wireless data communication networks. In some implementations, the network interface 1016 may comprise a Universal Serial Bus (USB) to supply power or transmit data. In some embodiments, other wireless links known to those skilled in the art may also be implemented.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one 5 of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

What is claimed is:

1. A phonetic education device including:
a soft and durable body, wherein the soft and durable body is shaped as a three-dimensional representation of at least one alphanumerical character further including:
an exterior surface of the body;
an internal portion of the body;
one or more attachment mechanism located within the internal portion of the body or on the exterior surface of the body, wherein the one or more attachment mechanism is configured to at least temporarily secure the phonetic education device to at least one external device;
an audio emitting device located within the internal portion of the body,
wherein a first prerecorded audio is stored in at least one storage medium within the audio emitting device, wherein the first prerecorded audio corresponds to the at least one alphanumerical character represented by the body;
an activation mechanism on the exterior surface of the body, wherein the activation mechanism includes at least one electronic component that is communicatively coupled to the audio emitting device, wherein the at least one manipulation of activation mechanism causes at least the first prerecorded audio to be emitted from the audio emitting device.

2. The phonetic education device of claim 1, wherein the at least one external device is a second phonetic education device.

3. The phonetic education device of claim 2, wherein the audio emitting device is configured to emit a second prerecorded audio representative of a combination of the at least one alphanumerical characters of a first phonetic education device and the second phonetic education device.

4. The phonetic education device of claim 1, wherein the internal portion of the body further includes at least one controller communicatively coupled to the activation mechanism and audio emitting device such that the controller directs the audio emitting device to emit at least one prerecorded audio when at least one input signal is received from the activation mechanism.

5. The phonetic education device of claim 1, wherein the at least one prerecorded audio corresponds to the color of the phonetic education device, wherein the phonetic education device is configured to teach a user to learn to identify color.

6. The phonetic education device of claim 1, at least one visual indicator on the exterior surface of the body, wherein the visual indicator includes a visual representation of at least one sound to be emitted from the at least one audio emitting device.

7. The phonetic education device of claim 1, wherein the internal portion of the body includes a power source configured to receive an electric current from at least one external power source via a receiving mechanism;

8. A phonetic education system including:
a plurality of phonetic education devices, wherein each phonetic education device includes:
a soft and durable body, wherein the soft and durable body is shaped as a three-dimensional representation of at least one alphanumerical character further including:
an exterior surface of the body;
an internal portion of the body;
one or more attachment mechanism located within the internal portion of the body or on the exterior surface of the body, wherein the one or more attachment mechanism is configured to at least temporarily secure the phonetic education device to at least one other phonetic education device;
an audio emitting device located within the internal portion of the body, wherein a first prerecorded audio is stored in at least one storage medium within the audio emitting device, wherein the at least one prerecorded audio corresponds to the at least one alphanumerical character represented by the body;
an activation mechanism on the exterior surface of the body, wherein the activation mechanism includes at least one electronic component that is communicatively coupled to the audio emitting device, wherein the at least one manipulation of the activation mechanism causes the first prerecorded audio to be emitted from the audio emitting device;
at least one controller device communicatively coupled to the activation mechanism and audio emitting device such that the controller device directs the audio emitting device to emit the first prerecorded audio when at least one input signal is received from the activation mechanism;
at least one sensing device communicatively coupled to the at least one controller device, wherein the at least one sensing device is configured to detect and determine the presence of an adjacent phonetic education device and prompt the at least one audio emitting device to emit an audio representation of the combination of the alphanumerical characters of the coupled plurality of phonetic education devices.

9. The phonetic education system of claim 8, wherein the plurality of phonetic education devices includes a mathematical symbol, wherein placing the mathematical symbol between at least a portion of the plurality of phonetic education devices prompts the at least one audio emitting device to emit an audio representation of the combination of the alphanumerical characters and coupled mathematical symbols.

10. The phonetic education system of claim 8, wherein the plurality of phonetic education devices includes a punctuation mark, wherein placing the punctuation mark between at least a portion of the plurality of phonetic education devices prompts the at least one audio emitting device to emit an audio representation of the combination of alphanumerical symbols as modified by the punctuation mark.

11. The phonetic education system of claim 8, wherein the at least one audio emitting device is configured to emit a second prerecorded audio corresponding to a notification sound if the plurality of phonetic education devices that are adjacent to one another cannot logically combine.

12. The phonetic education system of claim 8, at least one visual indicator on the exterior surface of the body, wherein the visual indicator includes a visual representation of at least one sound to be emitted from the at least one audio emitting device.

13. The phonetic education system of claim 8, wherein the at least one sensing device is in the form of a proximity sensor.

14. The phonetic education system of claim 8, wherein one or more software instructions within the controller provides instructions via the at least one audio emitting device on how to spell or add certain alphanumerical shapes.

15. The phonetic education system of claim 8, wherein at least a portion of the plurality of phonetic education systems include at least one transmitting device, wherein the transmitting device is communicatively coupled to at least one controller to enable each phonetic education device to transmit data wirelessly to at least one computing device.

16. The phonetic education system of claim 15, wherein the at least one computing device includes a software application configured to direct a user to form one or more combinations of the plurality of phonetic education devices.

17. The phonetic education system of claim 16, wherein the at least one computing device is configured to present a picture or image to a user via at least one display screen.

18. The phonetic education system of claim 8, wherein the plurality of phonetic education devices includes at least one connecting mechanism to physically join at least a portion of the adjacent phonetic education devices.

19. The phonetic education system of claim 8, wherein the at least one connecting mechanism is a magnet.

20. The phonetic education system of claim 19, wherein the magnets of each phonetic education device may be communicatively coupled to at least one controller associated therewith, such that the controllers of coupled phonetic education devices is able to determine an ordered sequence of the joined phonetic education devices.
